(19) United States
(12) Patent Application Publication
(10) Pub. No.: US 2013/0158447 A1
(43) Pub. Date: Jun. 20, 2013

(54) LIP PLUMPING DEVICE

(71) Applicant: Lilita Shabazian, San Salvador (SV)

(72) Inventor: Lilita Shabazian, San Salvador (SV)

(21) Appl. No.: 13/329,388

(22) Filed: Dec. 19, 2011

(51) Int. Cl. A61H 1/00

(52) U.S. Cl. 601/46

(57) ABSTRACT

A lip plumping device that clamps on the lip of the user, and vibrates to increase blood flow to the lip, to plump the lip. The clamp is adjustable.

### FIELD OF THE INVENTION

This invention relates to enlarge or plump lips to enhance the lips visual appearance. This is done by a lip clamp vibrating the lip of the user.

### BACKGROUND OF THE INVENTION

The present invention is a lip plumping device that receives at least a portion of the upper lip, or lower lip, and vibrates while in contact with the user's lip. Thus increasing blood flow to the lips and thus creating a temporary effect of enlarging lip tissue.

U.S. Patent Application Publication Number 2003/0212388 (“the '388 patent”) discloses, “A cosmetic enhancement device for enhancement of at least one of at least a portion of the lip area . . . ” This is accomplished by placing the device in the user's mouth.

U.S. Patent Application Publication Number 2007/0016277 (“the '277patent”) discloses, “The present invention is of a method of facilitating lip augmentation, the method comprising treating the lip area with an electricity generating device.” This invention uses electricity that contacts the lips to augment them.

U.S. Patent Application Number 2009/0306577 (“the '577 patent”) discloses, “The applicator includes a housing and a motor contained therewithin which includes an output member, such as a shaft, which, which in operation moves in a reciprocating manner.” This is performed so as to increase the absorption of a skin formulation.

The disclosure provides:
“9. The applicator of claim 8 wherein the applicator is sufficiently long and otherwise configured so that motor action does not produce significant vibrations to the housing.”
“In operation, while the embodiment disclosed above includes an on/off switch, it should be understood that other means for initiating operation of the applicator can be used. This includes a proximity switch which would initiate operation upon initial contact with or close proximity of the contact member and the skin. Also, the length and configuration of the applicator disclosed above has been found to be advantageous for the particular motor disclosed, as it reduces significantly any vibration action of the motor being transferred to the handle. The applicator is hence easy and comfortable to use.”

U.S. Pat. No. 6,478,755 (“the '755 patent) discloses, “A hand held massage unit used for therapeutic purposes such as to loosen and mobilize bronchial secretions in patients, to improve blood circulation, and to relax muscles.

U.S. Pat. No. 4,846,158 (“the '158 patent”) discloses, “In a hand type electric massage machine, a vibration head is connected through a coupling spring to a top end portion.

A lip plumping device that uses a vacuum to attempt to plump lips exists, and is called Luscious Lips® by Cynthia Rowland.

There exists a need for a device that can plump lips by being in vibrating contact with the lips.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the present invention is a lip plumping device 10, comprising: a handle 20; a vibrating member 100 secured to said handle so as to vibrate with respect to said handle 20; and a first member 40 secured to said vibrating member 100; and a second member 50 secured to said vibrating member 100; whereby when a lip is placed between said first member 40 and said second member 50 the vibrating member 100 vibrates the lip.

Another aspect is a lip plumping device 10, comprising: a handle 20 having an electric vibrating motor operably secured therein; a switch 30 that turns said motor on and off; a vibrating member 100 connected to said electric vibrating motor so that when said electric vibrating motor is on, said vibrating member 100 vibrates; a body 90 connected to said vibrating member 100; a first member 40 extending away from said body 90; a second member 50 extending away from said body 90 in the same direction as said first member 40 to form a lip clamp 110; said second member 50 being about the same size as said first member 40; a member adjustment means 60 to adjust said lip clamp 110; said handle 20 is about 6½ inches long; said first member 40 and said second member 50 are both about ½ inch long, and at least one of either said first member 40 or said second member 50 can be adjusted via the member adjustment means 60 to be in contact with each other, and to adjust up to be about one inch apart, and said first member 40 and said second member 50 are both about 1.5 inches wide.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of an embodiment of the present invention; and

FIG. 3 is another pictorial view of an embodiment of the present invention.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

### DETAILED DESCRIPTION

### Reference Numerals List

10 lip plumping device
20 handle
30 switch
40 first member
50 second member
60 member adjustment means
70 grip
80 electrical cord
90 body
100 vibrating member
110 lip clamp
120 end
130 longitudinal axis

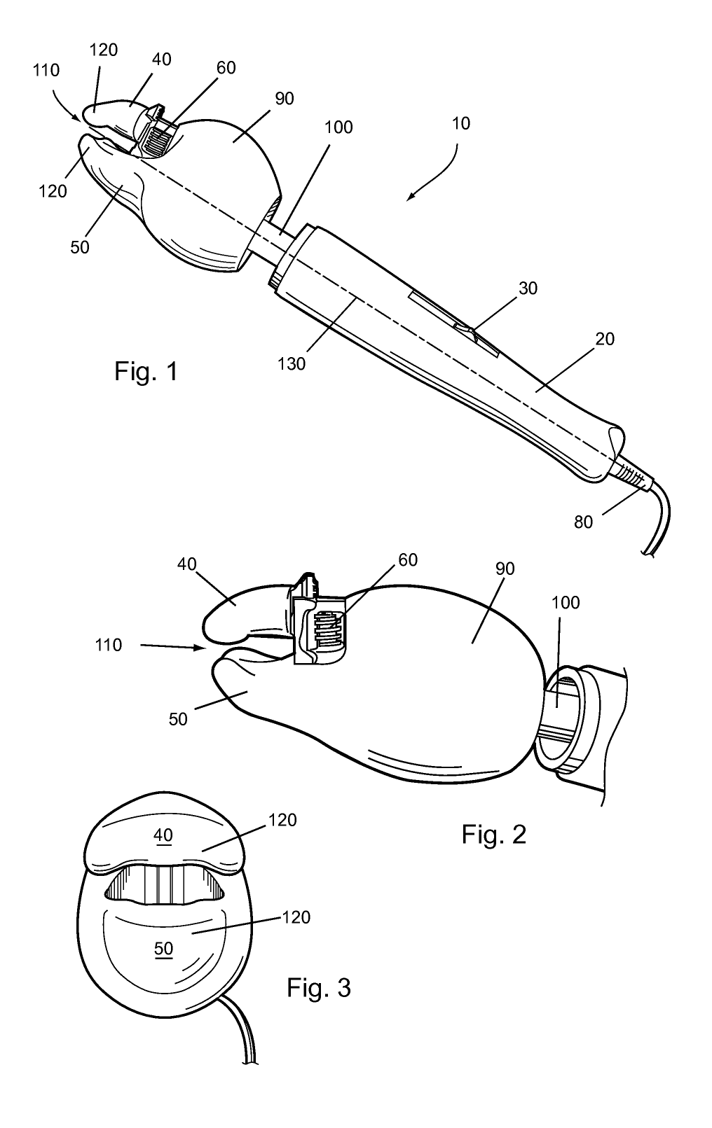

FIG. 1 represents a pictorial of one embodiment of the present invention 10, also called a lip plumping device 10. This embodiment may have a switch 30 operably disposed on a handle 20 to turn the device 10 on or off. The lip plumping device 10 may be battery operated, or it may have an electrical cord 80 that can be plugged in to receive electrical power.

A vibrating member 100 may be movably secured to an inside of the handle 20. The vibrating member 100 may extend away from the handle 20 and may terminate at a body 90. Extending from the body 90 may be a first member 40. A second member 50 may also extend from the body 90 in the same direction and with a similar configuration as the first member 40 so as to form a lip clamp 110. The first member 40 and second member 50 may each have an end 120 that is separated from the other end 120 by just about 3/16 of an inch, and may bias toward each other so as to be able to clamp on the user's upper or lower lip. The separation distance may be more or less than about 3/16 of an inch.

The first member 40 and the second member 50 may each have an end 120 that when placed on the user's lip, compresses the lip so that when the lip plumping device 10 is turned on the first member 40 and the second member 50 remain in contact with the lip. The user can remove the first member 40 and second member 50 from being in compression with the users lip by pulling the lip plumping device 10 away from the user's lip.

The first member 40 and second member 50 may extend away from the body 90 by a length of about ½ of an inch. The length may be more or less then ½ of an inch.

The user's lip can be placed in between the first member 40 and the second member 50 by separating the ends 120 with the user's fingers from their left hand, while moving the lip plumping device with their right hand, as an example.

Alternatively, the first member 40 and the second member 50 can be separated by about an inch via the member adjustment means 60, and then a lip can be place between each member 40, 50, and then the first member 40 can be adjusted toward to second member 50 via the member adjustment means 60, so that the lip is firmly secured between the first member 40 and the second member 50.

The vibrating member 100 may vibrate in a reciprocating manner parallel with the longitudinal axis 130. In another embodiment the vibrating member 100 may vibrate up and down with respect to the user's face. In another embodiment the vibrating member 100 may vibrate rotationally or radially with respect to a longitudinal axis 130.

In another embodiment, the distance that one end 120 is from the other end 120 may be adjustable by a member adjustment means 60. In one embodiment, the member adjustment means 60 may work like the teeth and mechanism of an adjustable wrench, or a pipe wrench, as an example

FIG. 2 illustrates a closer view of the body 90. The vibrating member 100 may be received by an inside of the handle 20. The vibrating mechanism (not illustrated) may also be inside the handle to vibrate the vibrating member 100 with respect to the handle 20.

FIG. 3 illustrates a front view of the first member 40 and second member 50, and the respective ends 120.

In a further embodiment, the present invention improves circulation to the lips and in turn may plump up the lip tissue for a 12-hour period. The present invention may be about 6-7 inches long with a motor inside the handle 20 and a vibrating body 90 attachment. The body 90 may have a clamp-like lip encasing shape 110 that can be customized to each person's lips via the member adjustment means 60. The first member 40 and second member 50 can be clamped to the lip (separately upper and lower lips) and then tightened via the member adjustment means 60. After the lip clamp 110 is tight and secure on the lip, the user will turn the device 10 via the switch 30 on which may send a 6000 rpm or 4000 rpm vibration to the lip clamp 110. The device 10 can be operated for 30 sec-3 minutes per lip, depending on desired plumping effect. The device 10 may feature a 60 Hz intensity and 2 different vibration settings (6000 rpm and 4000 rpm).

In another embodiment the vibrating member 100 is vibrated or displaced by a small vibrator motor, such as any of the Vibration General™ or Shaker™ motors at www.precisionmicrodrives.com. The present invention may also use the same motor as is used in the Hitachi® Magic Wand®.

Also, at least one of either the first member 40 or said second member 50 can be adjusted via the member adjustment means 60 to be in contact with each other, and to adjust up to be about one inch apart.

In one embodiment the first member 40 and the second member 50 may be about 1.5 inches wide, so that the lip is contacting about 1.5 inches of the first member 40 on the top, and about 1.5 inches of the second member on the bottom of the lip.

Although particular preferred embodiments of the invention have been discussed in detail for illustrative purposes, it will be recognized that variations or modifications of the disclosed apparatus, including the rearrangement of parts, lie within the scope of the present invention.

I claim:

1. A lip plumping device (10), comprising:
a handle (20);
a vibrating member (100) secured to said handle so as to vibrate with respect to said handle (20); and
a first member (40) secured to said vibrating member (100); and
a second member (50) secured to said vibrating member (100);
whereby when a lip is placed between said first member (40) and said second member (50) the vibrating member (100) vibrates the lip.

2. The apparatus of claim 1, further comprising:
a switch (30) operably disposed on said handle (20)
whereby said limp plumping device can be turned on and off via said switch (30).

3. The apparatus of claim 1, further comprising
a member adjustment means (60) to adjust the distance between said first member 40 and said second member (50).

4. The apparatus of claim 1, further comprising:
a member adjustment means (60) to adjust the lip clamp.

5. The apparatus of claim 1 wherein the handle (20) is about 6½ inches long.

6. The apparatus of claim 1 wherein said first member (40) and said second member (50) are both about ½ inch long, and at least one of either said first member (40) or said second member (50) can be adjusted via the member adjustment means (60) to be in contact with each other, and to adjust up to be about one inch apart, and
said first member (40) and said second member (50) are both about 1.5 inches wide.

7. A lip plumping device (10), comprising:
a handle (20) having an electric vibrating motor operably secured therein;
a switch (30) that turns said motor on and off;
a vibrating member (100) connected to said electric vibrating motor so that when said electric vibrating motor is on, said vibrating member (100) vibrates;
a body (90) connected to said vibrating member (100);
a first member (40) extending away from said body (90);
a second member (50) extending away from said body (90) in the same direction as said first member (40) to form a lip clamp (110); said second member (50) being about the same size as said first member (40);
a member adjustment means (60) to adjust said lip clamp (110);
said handle (20) is about 6½ inches long;
said first member (40) and said second member (50) are both about ½ inch long, and at least one of either said first member (40) or said second member (50) can be adjusted via the member adjustment means (60) to be in contact with each other, and to adjust up to be about one inch apart, and said first member (40) and said second member (50) are both about 1.5 inches wide.
